(19) United States
(12) Patent Application Publication
(10) Pub. No.: US 2023/0270044 A1
(43) Pub. Date: Aug. 31, 2023

(54) ROBOTIC MOWER HAVING MULTIPLE OPERATING MODES

(71) Applicant: THE TORO COMPANY, Bloomington, MN (US)

(72) Inventors: Alexander Steven Frick, Farmington, MN (US); Gregory S. Janey, Excelsior, MN (US)

(21) Appl. No.: 17/768,615

(22) PCT Filed: Nov. 3, 2020
(86) PCT No.: PCT/US2020/058629

§ 371 Date: Apr. 13, 2022

Related U.S. Application Data
(60) Provisional application No. 62/934,696, filed on Nov. 13, 2019.

(51) Int. Cl. A01D 34/00; A01D 34/84; A01D 34/64; A01D 34/78; A01D 75/18; A01D 34/82

(52) U.S. Cl. CPC A01D 34/008; A01D 34/84; A01D 34/64; A01D 34/78; A01D 75/185; A01D 34/82; A01D 2101/00

(57) ABSTRACT

Apparatus, systems, and methods for operating an autonomous vehicle. In some embodiments, the vehicle is embodied as a mower having a downwardly extending sidewall and a cutting blade assembly. The cutting blade assembly is adapted to cut grass along a path defining a proximal cut edge located at a first distance from the sidewall when the mower is configured in a first operating mode, and at a second distance from the sidewall when the mower is configured in a second operating mode. The mower is adapted to automatically switch from the first operating mode to the second operating mode when an electronic controller associated with the mower determines a local area of operation of the mower is free of unknown objects.

This application claims priority to and/or the benefit of U.S. Provisional Patent Application No. 62/934,696, filed Nov. 13, 2019, the content of which is incorporated herein by reference in its entirety.

Embodiments of the present disclosure relate to autonomous working machines (e.g., robotic lawn mowers) and, more particularly, to systems and methods for automatically (or semi-automatically) selecting an operating (e.g., cutting) mode of the mower based upon a detected operating situation and/or remote operator command.

### BACKGROUND

Lawn and garden machines are known for performing a variety of tasks. For instance, powered lawn mowers are used by both homeowners and professionals alike to maintain turf areas within a property or yard.

Mowers that autonomously perform a grass cutting function are also known. Autonomous mowers typically include a cutting deck having one or more cutting blades. One or more battery-powered electric motors typically power both the cutting blades and a mower propulsion system. Depending on the property size, the mower may cut only a portion of the property before returning to a base station for battery re-charging.

Autonomous mowers typically cut grass in a random travel pattern within the property boundary. In some configurations, the property boundary is defined by a continuous boundary marker, e.g., an energized wire laying on, or buried beneath, the lawn. Such boundary wires may also extend into the interior of the yard to demarcate obstacles (e.g., trees, flower beds, etc.) or other excluded areas. The mower may then move randomly within the areas delineated by the boundary wire.

Autonomous mowers by definition may operate without direct operator involvement. Due to this lack of direct operator interaction, such mowers often position the cutting blades sufficiently inboard from an edge or sidewall of the cutting deck to minimize, for instance, inadvertent contact of the blades with foreign objects.

While effective, locating the cutting blades at such an inboard position makes trimming (i.e., mowing close to obstacles and boundaries such as buildings and landscaping) difficult as the cutting blades are spaced-apart from the sidewalls of the cutting deck. As a result, a secondary, manual trimming device (e.g., conventional mower or string trimmer) may be required to mow these areas unreachable by the autonomous mower. Moreover, placing the cutting blades at such an inboard location relative to the sidewalls yields a mower with a cutting width that is smaller, and often substantially smaller, than the cutting deck width. Accordingly, complete work region coverage may require significantly more mower passes as compared to a conventional mower having a cutting width generally corresponding to the deck width.

### SUMMARY

Embodiments described herein may provide a lawn mower including: a housing comprising downwardly extending sidewalls; ground support members adapted to support the housing upon a ground surface; and a cutting blade assembly comprising at least one selectively-activated cutting blade. The cutting blade assembly is adapted to cut grass along a path located at a first distance from the sidewall when the mower is configured in a first operating mode, and at a second distance from the sidewall when the mower is configured in a second operating mode, the second distance being less than the first distance.

In another embodiment, a lawn mower is provided that includes: a housing comprising a downwardly extending sidewall; ground support members adapted to support the housing upon a ground surface; and first and second cutting blade assemblies carried by the housing, wherein the first and second cutting blade assemblies are transversely spaced-apart from one another with the second cutting blade assembly being located proximate the sidewall. The mower further includes: an electronic controller adapted to control rotation of the first and second cutting blade assemblies; and a sensor in communication with the controller. The controller, via the sensor, is adapted to detect the presence of an unknown object within a local area of operation of the mower, and is further adapted to automatically disable the second cutting blade assembly while maintaining operation of the first cutting blade assembly when the unknown object is detected within the local area of operation.

In yet another embodiment, a method for operating an autonomous lawn mower is provided that includes locating the mower within a defined work region. The mower includes: a housing comprising an upper wall and a downwardly extending sidewall; wheels adapted to support the housing in rolling engagement upon a ground surface; and a cutting blade assembly comprising at least one selectively-activated cutting blade. The cutting blade assembly is adapted to cut grass along a path located at a first distance from the sidewall when the mower is configured in an autonomous first operating mode, and at a second distance from the sidewall when the mower is configured in an autonomous second operating mode, the second distance being less than the first distance. The method further includes: autonomously operating the mower in the second operating mode within the work region; automatically detecting, with an electronic controller associated with the mower, an unknown object within a local area of operation; automatically switching, with the controller, the mower from the second operating mode to the first operating mode; and autonomously operating the mower in the first operating mode.

According to an independent first aspect of the disclosure, an autonomous lawn mower is provided including: a housing having a downwardly extending sidewall; ground support members adapted to support the housing upon a ground surface of a work region in which the mower operates; and a cutting blade assembly supported by the housing. The cutting blade assembly includes at least one selectively-activated cutting blade, wherein the cutting blade assembly is adapted to cut grass along a path defining a proximal cut edge located at a first distance from the sidewall when the mower is configured in a first operating mode, and at a second distance from the sidewall when the mower is configured in a second operating mode, the second distance being less than the first distance. The mower is adapted to automatically switch from the first operating mode to the second operating mode when an electronic controller associated with the mower determines a local area of operation of the mower is free of unknown objects.

In a second aspect according to the first aspect, the cutting blade assembly shifts laterally, relative to the housing, as the mower automatically switches between the first and second operating modes. In a third aspect according to any one of the preceding aspects, the sidewall moves, relative to the cutting blade assembly, as the mower automatically switches between the first and second operating modes. In a fourth aspect according to any one of the preceding aspects, the cutting blade assembly includes a powered first cutting blade assembly and a powered second cutting blade assembly, wherein the second cutting blade assembly is activated when the mower is in the second operating mode and is deactivated when the mower in in the first operating mode. In a fifth aspect according to any one of the preceding aspects, the mower is adapted to automatically switch to the first operating mode upon detection of an unknown object within the local area of operation of the mower. In a sixth aspect according to any one of the preceding aspects, the mower includes a radio adapted to transmit a notification to a remote computer before the mower switches to the second operating mode.

According to an independent seventh aspect of the disclosure, a method for operating an autonomous lawn mower is provided that includes locating the mower within a defined work region. The mower includes: a housing having an upper wall and a downwardly extending sidewall; wheels adapted to support the housing in rolling engagement upon a ground surface; and a cutting blade assembly including at least one selectively-activated cutting blade. The cutting blade assembly is adapted to cut grass along a path defining a proximal cut edge located at a first distance from the sidewall when the mower is configured in an autonomous first operating mode, and at a second distance from the sidewall when the mower is configured in an autonomous second operating mode, the second distance being less than the first distance. The method also includes: autonomously operating the mower in the second operating mode within the work region; automatically detecting, with an electronic controller associated with the mower, an unknown object within a local area of operation of the mower; automatically switching, with the controller, the mower from the second operating mode to the first operating mode; and autonomously operating the mower in the first operating mode.

In an eighth aspect according to the seventh aspect, the method further includes: monitoring, with the controller, the local area of operation; detecting when the unknown object is no longer present within the local area of operation; automatically switching, with the controller, the mower from the first operating mode to the second operating mode; and autonomously operating the mower in the second operating mode. In a nineth aspect according to the eighth aspect, the method further includes confirming that the unknown object is no longer present within the local area of operation using a remote sensor. In a tenth aspect according to any one of the seventh through nineth aspects, switching the mower from the second operating mode to the first operating mode includes laterally shifting the cutting blade assembly toward the sidewall. In an eleventh aspect according to the tenth aspect, shifting the cutting blade assembly toward the sidewall includes extending or retracting an actuator operatively connected to the housing and to the cutting blade assembly. In a twelfth aspect according to the tenth aspect, the upper wall further defines a slot, wherein the cutting blade assembly is slidable along the slot between a first position corresponding to the first operating mode of the mower, and a second position corresponding to the second operating mode of the mower. In a thirteenth aspect according to any one of the seventh through twelfth aspects, the cutting blade assembly includes a powered first cutting blade assembly and a powered second cutting blade assembly, wherein switching the mower from the second operating mode to the first operating mode includes deactivating the second cutting blade assembly while maintaining power to the first cutting blade assembly. In a fourteenth aspect according to any one of the seventh through thirteenth aspects, switching the mower from the second operating mode to the first operating mode includes operatively moving or removing the sidewall. In a fifteenth aspect according to any one of the seventh through fourteenth aspects, detecting the unknown object within the local area of operation includes detecting the unknown object using a vision-based sensor in communication with the controller. In a sixteenth aspect according to any one of the seventh through fifteenth aspects, the method further includes slowing propulsion of the mower when the unknown object is detected within the local area of operation. In a seventeenth aspect according to any one of the seventh through sixteenth aspects, the method further includes stopping propulsion of the mower when the unknown object is detected within the local area of operation.

According to an independent eighteenth aspect of the disclosure, a lawn mower is provided that includes: a housing having a downwardly extending sidewall; ground support members adapted to support the housing upon a ground surface; first and second cutting blade assemblies carried by the housing, wherein the first and second cutting blade assemblies are transversely spaced-apart from one another with the second cutting blade assembly being located proximate the sidewall; an electronic controller adapted to control rotation of the first and second cutting blade assemblies; and a sensor in communication with the controller, wherein the controller, via the sensor, is adapted to detect a presence of an unknown object within a local area of operation of the mower, and wherein the controller is adapted to automatically disable the second cutting blade assembly while maintaining operation of the first cutting blade assembly when the unknown object is detected within the local area of operation.

In a nineteenth aspect according to the eighteenth aspect, the sensor includes a vision-based sensor. In a twentieth aspect according to any one of the eighteenth and nineteenth aspects, the local area of operation includes an area adjacent one or more of front, left, right, and rear sides of the mower.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a diagrammatic side view of an autonomous grounds maintenance machine, e.g., lawn mower, in accordance with embodiments of the present disclosure;

FIG. 2 is a bottom plan view of an exemplary autonomous mower like that of FIG. 1, showing a cutting blade assembly of the mower positioned for operation in a first operating (e.g., cutting) mode;

FIG. 3 is a bottom plan view of the mower of FIG. 2, but with the cutting blade assembly positioned for operation in a second operating mode;

FIG. 4 is a top plan view of a partial work region illustrating trim paths, a local area of operation, and an unknown object in accordance with embodiments of the present disclosure;

FIG. 5 is an exemplary graphical depiction of the partial work region of FIG. 4 as presented on a display of a remote computer;

FIG. 6 is a top plan view of the mower of FIG. 2 operating within a work region in the first operating mode;

FIG. 7 is a top plan view of the mower of FIG. 3 operating within the work region in the second operating mode;

FIG. 8 is a diagrammatic bottom view of a mower in accordance with embodiments of the present disclosure illustrating a cutting blade assembly positioned in both the first operating mode and the second operating mode(s);

FIG. 9 is a diagrammatic bottom view of a mower in accordance with other embodiments of the present disclosure illustrating an alternative cutting blade assembly configuration; and

FIG. 10 is a diagrammatic bottom view of a mower in accordance with still other embodiments of the present disclosure illustrating multiple cutting blade assemblies in conjunction with a movable shroud or sidewall.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” Further, the term “and/or” (if used) means one or all of the listed elements or a combination of any two or more of the listed elements. Still further, “i.e.” is used herein as an abbreviation for the Latin phrase id est, and means “that is,” while “e.g.” is used as an abbreviation for the Latin phrase exempli gratia and means “for example.”

Embodiments of the present disclosure are directed to autonomous working machines or vehicles and to methods of operating the same within a defined work region of a property. Such machines may operate autonomously and may automatically (or under operator control) change operating modes based upon detected situational parameters, or upon remote operator command. For example, the vehicle may be an autonomous lawn mower having one or more cutting members or blades adapted to cut grass as the mower travels over the work region. The mower may autonomously operate in a first operating (cutting) mode in which the cutting member is offset by at least a first distance from an edge (e.g., sidewall) of the mower housing. The first distance is selected to minimize potential contact with the cutting member if the mower were to be inadvertently grasped at or near (or if an object were inadvertently inserted beneath) the sidewall. While effective at mowing, such cutting member positioning may complicate the ability of the mower to cut grass close to a boundary (e.g., work region boundary, building, tree, landscape edging, etc.) of the work region. Moreover, such positioning may further reduce work region coverage efficiency.

Unlike conventional autonomous mowers, however, mowers in accordance with embodiments of the present disclosure may further incorporate features (e.g., vision-based and other sensors) that permit the mower to detect objects (e.g., animals, people) in its vicinity and/or in its intended travel path. If such objects are not detected, the mower may automatically reconfigure to a second operating mode and continue autonomous operation. In the second operating mode, one or more of the cutting members may be effectively positioned a second distance from the edge or side of the mower housing that is less than the first distance (e.g., the second distance may, in some embodiments, be effectively zero). In still other embodiments, the cutting member may, when the mower is in the second operating mode, even extend outwardly beyond the edge (e.g., sidewall) of the mower housing as described below. As a result, operation of the mower in the second operating mode allows the mower to more effectively trim closer to boundaries of, and objects within, the work region. Moreover, in some embodiments, the second operating mode may effectively increase the cutting width of the mower, increasing overall cutting efficiency.

As used herein, “property” is defined as a geographic region (such as a yard) circumscribed by a fixed property boundary within which the vehicle (e.g., mower) may perform work (e.g., mow grass). “Work region” is used herein to refer to those areas contained (or mostly contained) within the property boundary within which the vehicle will perform work. For example, work regions could be defined by grass surfaces of a residential or commercial property upon which an autonomous lawn mower will operate. A property may contain one or more work regions (e.g., a front yard area and a back yard area, or two yard areas separated by a sidewalk or driveway).

The second operating mode is, in some embodiments, achieved by activating one or more secondary cutting members that are disabled during the first operating mode. Such secondary cutting members are operable to cut grass closer to the edge of the mower housing. In yet other embodiments, the second operating mode may be achieved by moving or shifting one or more cutting members relative to the housing from an inboard location to a more outboard location. In still yet other embodiments, the second operating mode may be achieved by reconfiguring the mower housing. For instance, an edge of the housing may be displaced (e.g., extended/retracted, folded, removed, etc.) to effectively change the distance between the cutting member and the edge of the housing. In some embodiments, reconfiguration of the mower between the first and second operating modes may occur automatically based upon detected parameters during operation.

While described herein as a mower, such a configuration is exemplary only as systems and methods described herein may also have application to other autonomously operated vehicles including, for example, commercial turf products, other ground working vehicles (e.g., debris blowers/vacuums, aerators, material spreaders, snow throwers), as well as indoor working vehicles such as vacuums and floor scrubbers/cleaners.

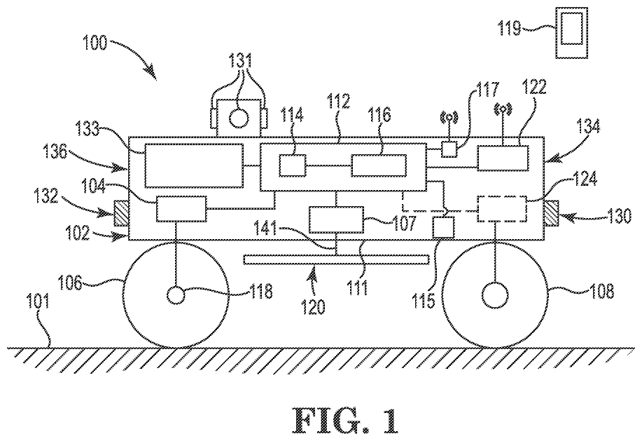

It is noted that the terms “have,” “includes,” “comprises” and variations thereof do not have a limiting meaning and are used in their open-ended sense to generally mean “including, but not limited to,” where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the vehicle (e.g., mower 100) is operating upon a ground surface 101 as shown in FIG. 1. These terms are used only to simplify the description, however, and not to limit the interpretation of any embodiment described.

As used herein, the terms “determine” and “estimate” may be used interchangeably depending on the particular context of their use, for example, to determine or estimate the presence and/or position of an object relative to the mower 100.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

While the general construction of the autonomous working machine is not necessarily central to an understanding of embodiments of this disclosure, FIG. 1 illustrates one example of an autonomous lawn mower 100, which may form part of a lawn mowing system (for simplicity of description, the mower 100 is illustrated schematically in FIG. 1). As shown in this view, the mower 100 may include a housing 102 (e.g., frame or chassis with an optional shroud) that carries and/or encloses various components of the mower as described below. The mower 100 may further include ground support members, such as wheels, rollers, or tracks adapted to support the housing upon the ground surface 101 of the work region. In the illustrated embodiment, the ground support members include one or more rear wheels 106 (e.g., left rear wheel 106a and right rear wheel 106b) and one or more front wheels 108 (e.g., left front wheel 108a and right front wheel 108b), that support the housing 102 in rolling engagement upon the ground (grass) surface 101, i.e., the front wheels 108 may support a front-end portion 134 of the mower housing 102 while the rear wheels 106 support a rear end portion 136 of the mower housing.

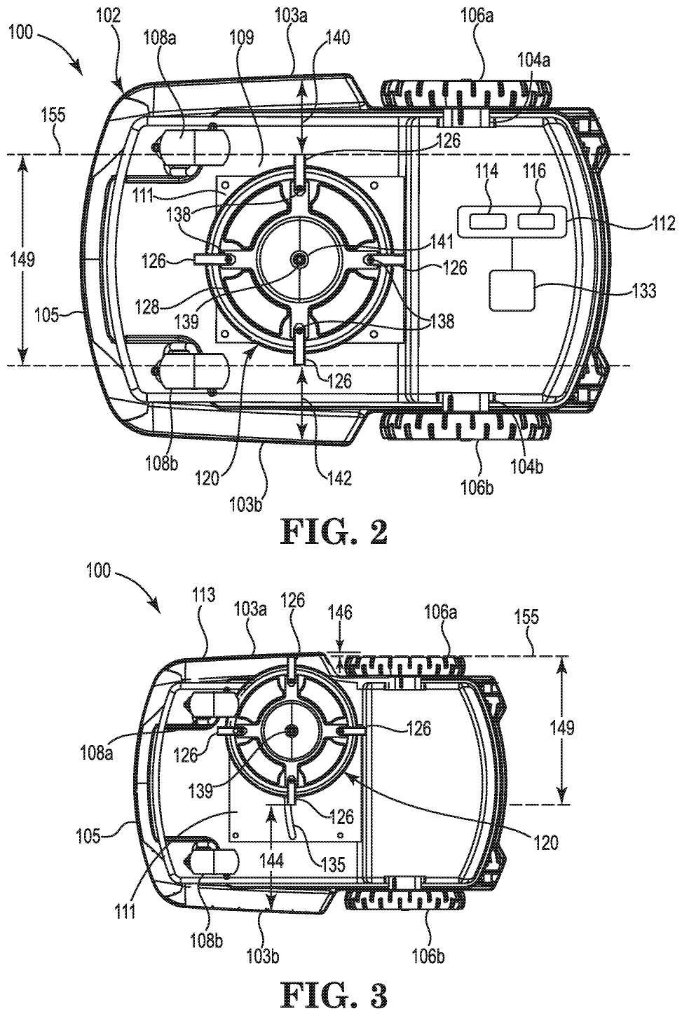

One or both rear wheels 106 may be powered or driven by a propulsion system (e.g., one or more electric propulsion or wheel motors 104) adapted to propel the mower 100 over the ground surface 101. In some embodiments, the front wheels 108 may freely caster relative to the housing 102 (e.g., about vertical axes). In such a configuration, mower direction may be controlled via differential rotation of the two rear wheels 106 in a manner similar to a conventional zero-turn-radius (ZTR) riding mower. That is to say, the propulsion system may include separate wheel motors 104a, 104b for left and right rear wheels 106a, 106b (see FIG. 2), respectively, so that speed and direction of each rear wheel may be independently controlled. In addition, or alternatively, the front wheels 108 could be actively steerable by the propulsion system (e.g., including one or more steer motors 124) to assist with control of mower 100 direction, and/or could be driven by the propulsion system (i.e., to provide a front-wheel or all-wheel drive mower).

A powered implement (e.g., a grass cutting member, such as a cutting blade assembly 120) may be coupled to a cutting motor 107 (e.g., implement motor) carried by the housing 102. When the motors 107 and 104 are activated or energized, the mower 100 may be propelled over the ground surface 101 such that vegetation (e.g., grass) over which the mower passes is cut by the cutting blade assembly. While illustrated in FIG. 1 as using only a single cutting blade assembly 120 and motor 107, mowers incorporating multiple cutting blade assemblies, powered by a single or multiple motors, are possible within the scope of this disclosure (some embodiments of which are further described below). Moreover, while described herein in the context of having conventional cutting “blades,” other cutting members including, for example, disks, nylon string or line elements, knives, cutting reels, etc., are certainly possible without departing from the scope of this disclosure. Accordingly, the term “blade” as used herein may include any acceptable vegetation cutting member without departing from the scope of this disclosure. Still further, embodiments combining various cutting elements, e.g., a rotary blade and a string trimmer, are also contemplated.

The mower 100 may further include a power source, which in one embodiment, is a battery 133 having a lithium-based chemistry (e.g., lithium-ion). Other embodiments may utilize batteries of other chemistries, or other power source technologies (e.g., solar power, fuel cell, internal combustion engines) altogether. It is further noted that, while shown as using independent blade and wheel motors 107 and 104, such a configuration is illustrative only as embodiments wherein blade and wheel power is provided by a single motor are also envisioned.

The mower 100 may further include one or more sensors to provide location data. For instance, some embodiments may include a global positioning system (GPS) receiver 122 (or other position sensor that may provide similar data) that is adapted to estimate a position of the mower 100 within the work region and provide such information to a controller 112 (described below). In other embodiments, one or more of the wheels 106, 108 may include an encoder 118 that provides wheel rotation/speed information (odometry data) that may be used to estimate mower position (e.g., based upon an initial start position) within the work region. The mower 100 may also include a sensor 115 adapted to detect a boundary wire, which could be used alternatively or in addition to other navigational techniques.

The mower 100 may optionally include one or more front obstacle detection sensors 130 and one or more rear obstacle detection sensors 132, as well as other sensors, such as side obstacle detection sensors (not shown). The obstacle detection sensors 130, 132 may be used to detect an obstacle in the path of the mower 100 when travelling in a forward or reverse direction, respectively. The mower 100 may be capable of mowing while moving in either direction. As illustrated, the sensors 130 and 132 may be located at the front-end portion 134 and rear end portion 136 of the mower 100, respectively.

The sensors 130, 132 may use contact sensing, non-contact sensing, or both types of sensing. For example, both contact and non-contact sensing may be enabled concurrently or only one type of sensing may be used depending on the status of the mower 100. One example of contact sensing includes using a contact bumper protruding from the housing 102, or from a shroud forming a part of the housing, that can detect when the mower 100 has contacted the obstacle. Non-contact sensors may use acoustic or light waves to detect the obstacle, sometimes at a distance from the mower 100 before contact with the obstacle (e.g., using infrared, radio detection and ranging (radar), light detection and ranging (lidar), etc.).

In some embodiments, the mower 100 may also include one or more vision-based sensors in communication with the controller 112 to provide and/or correct localization data (e.g., position, orientation, and/or velocity), as well as object detection, during mower operation. The vision-based sensors may include one or more cameras 131 that capture and/or record images for use with a vision system. The cameras 131 may be described as part of the vision system of the mower 100. While not limiting, types of images captured may include, for example, training images and/or operating images.

The one or more cameras may be capable of detecting visible light, non-visible light, or both. The one or more cameras may establish a total field of view of at least 30 degrees, at least 45 degrees, at least 60 degrees, at least 90 degrees, at least 120 degrees, at least 180 degrees, at least 270 degrees, or 360 degrees, around the autonomous machine (e.g., mower 100). The field of view may be defined in a horizontal direction, a vertical direction, or both directions. For example, a total horizontal field of view may be 360 degrees, and a total vertical field of view may be 45 degrees. The field of view may capture image data above and below the height of the one or more cameras.

In some embodiments, the mower 100 includes four cameras 131. One camera 131 may be positioned in each of one or more of directions including a forward direction, a reverse direction, a first (left) side direction, and a second (right) side direction (e.g., Cardinal directions relative to the mower 100). One or more camera directions may be positioned orthogonal to one or more other cameras 131 or positioned opposite to at least one other camera 131. The cameras 131 may also be offset from any of these directions (e.g., at a 45 degree or another non-right angle).

Sensors of the mower 100 may also be described as either vision-based sensors or non-vision-based sensors. Vision-based sensors may include cameras 131 that are capable of capturing and/or recording images/image data. Non-vision-based sensors may include any sensors that are not cameras 131. For example, wheel encoders 118 that uses optical (e.g., photodiode), magnetic, or capacitive sensing to detect wheel revolutions may be described as a non-vision-based sensor. In addition to the sensors described above, other sensors now known or later developed may also be incorporated into the mower 100.

The mower 100 may also include the electronic controller 112 adapted to monitor and control various mower functions. As used herein, the term “controller” may be used to describe electronic components of a “system” that receive inputs and provide commands to control various other components of the system. The exemplary controller 112 has a processor 114 that receives various inputs and executes one or more computer programs or applications stored in memory 116. The memory 116 may include computer-readable instructions or applications that, when executed, e.g., by the processor 114, cause the controller 112 to perform various calculations and/or issue commands. That is to say, the processor 114 and memory 116 may together define a computing apparatus operable to process input data and generate the desired output to one or more components/devices. For example, the processor 114 may receive various input data including positional data from the GPS receiver 122 and/or encoders 118 and generate speed and steering angle commands to the drive wheel motor(s) 104 to cause the drive wheels 106 to rotate (at the same or different speeds and in the same or different directions). In other words, the controller 112 may control the steering angle and speed of the mower 100, as well as the rotation (e.g., speed and operation) of the cutting blade assembly 120.

The controller 112 may use the processor 114 and memory 116 in various different systems, and a processor 114 and memory 116 may be included in each of the different systems. For example, the controller 112 may at least partially define a vision system, which may include a processor 114 and memory 116. The controller 112 may also at least partially define a navigation system, which may also include a processor 114 and memory 116 separate from the processor 114 and memory 116 of the vision system. Still further, the controller 112 may at least partially define an object detection system (e.g., for situational awareness), which may also include a processor 114 and memory 116 separate from the other systems. In yet other embodiments, a single processor 114 and memory 116 may be provide for all the mower systems.

In addition, the mower 100 may include a wireless radio 117 to permit operative communication with a separate device, such as a remote computer 119. The remote computer 119 may permit remote operator interaction with the mower 100/controller 112 when such interaction is beneficial or necessary.

In view of the above, it will be readily apparent that the functionality of the controller 112 may be implemented in any manner known to one skilled in the art. For instance, the memory 116 may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While shown as both being incorporated into the controller 112, the memory 116 and the processor 114 could be contained in separate modules.

The processor 114 may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor 114 may include multiple components, such as any combination of one or more microprocessors, one or more controllers, one or more DSPs, one or more ASICs, and/or one or more FPGAs, as well as other discrete or integrated logic circuitry. The functions attributed to the controller 112 and/or processor 114 herein may be embodied as software, firmware, hardware, or any combination of these. Certain functionality of the controller 112 may also be performed in the cloud or other distributed computing systems operably connected to the processor 114 (e.g., on the remote computer 119).

In FIG. 1, schematic connections are generally shown between the controller 112 and the battery 133, wheel motor(s) 104, blade motor 107, optional boundary wire sensor 115, wireless radio 117, and GPS receiver 122. These interconnections are illustrative only as the various components and subsystems of the mower 100 could be connected in most any manner, e.g., directly to one another, wirelessly, via a bus architecture (e.g., controller area network (CAN) bus), or any other connection configuration that permits data and/or power to pass between the various components of the mower. Although connections with some of the sensors 130, 132, 131 are not shown, these sensors and other components of the mower 100 may be connected in a similar manner. The wireless radio 117 may communicate over a cellular or other wide area network (e.g., over the internet), a local area network (e.g., IEEE 802.11 “Wi-Fi” radio), or a peer-to-peer (P2P) (e.g., BLUETOOTH™) network with the remote computer 119 (e.g., cellular telephone (“smartphone”), tablet, desktop, or wearable computer or server (local or remote)). In turn, the mobile computer 119 may communicate with other devices over similar networks and, for example, may be used to connect the mower 100 to the internet.

In some embodiments, various functionality of the controllers 112 described herein may be offloaded from the mower 100. For example, recorded images may be transmitted to a remote server (e.g., internet-connected or “cloud” server) using the wireless radio 117 and processed or stored. The images stored, or other data derived from processing, may be received using the wireless radio 117 and be stored on, or further processed by, the mower 100.

FIGS. 2 and 3 illustrate bottom plan views of a working vehicle, e.g., autonomous lawn mower 100, in accordance with embodiments of the present disclosure. The mower is shown in a first or offset operating mode in FIG. 2, and in a second or shifted operating mode in FIG. 3. As further described below, the mower 100 (e.g., the controller 112) may autonomously reconfigure between the first and second operating modes based upon detected operating circumstances of the mower. That is to say, the mower 100 may be situationally aware of various operational parameters and may automatically reconfigure between the two (or more) operating modes to optimize mowing functions. In other embodiments, the mower may be reconfigured between the first and second operating modes based upon an operator command.

As shown in FIGS. 2 and 3, the housing 102 may form an upper wall 111 and one or more downwardly extending sidewalls (e.g., left sidewall 103a, right sidewall 103b, and front sidewall 105) forming a cutting chamber 109. In some embodiments, some or all of the sidewalls may be formed by a perimeter bump shroud that may be used to detect contact with obstacles. The transverse outer edges of the left and right sidewalls 103 may extend outwardly to or beyond the rear wheel track width as shown. One or more of the sidewalls, e.g., the left and/or right sidewall 103, may form a trim edge of the mower when the mower is configured in the second operating mode.

The electric motor 107 (see FIG. 1) may be attached to the upper wall 111 of the housing 102. Once again, while illustrated herein as an electric motor 107, alternative prime movers, such as internal combustion engines, are also contemplated. Other components, e.g., the battery 133 (see also FIG. 1), may also be attached to the housing 102/upper wall 111.

The motor 107 may include an output shaft 141 that extends vertically downward (in FIG. 1) through the upper wall 111 of the housing 102 and into the cutting chamber 109. A ground-working tool (e.g., rotatable cutting blade assembly 120) may be supported by the housing, e.g., attached to a lower end of the shaft 141 and contained, at least partially, within the cutting chamber 109. While identified herein as a “chamber” 109, the cutting blade assembly 120 may operate irrespective of any “chamber” surrounding it. For example, the cutting blade assembly may operate, at least partially, at an elevation below that of the sidewalls 103.

One or more cutting blade assemblies 120 may be included, and each such assembly may have at least one selectively-activated cutting blade. For example, each cutting blade assembly may include a plurality of cutting blades 126 (e.g., four cutting blades) attached to a disk 128. In some embodiments, each of the cutting blades 126 may be pivotally attached to the disk 128 by a pin or fastener 138. The disk 128 may be attached, directly or indirectly, to the output shaft 141, by a fastener 139.

During operation, the output shaft 141 rotates the cutting blade assembly 120 at a speed sufficient to permit the blades 126 to sever grass and other vegetation over which the housing 102 passes. By pivotally connecting each cutting blade 126 to the rotating disk 128, the cutting blades are capable of incurring blade strikes against various objects (e.g., rocks, tree roots, etc.) without causing excessive damage to the blades 126, blade assembly 120, shaft 141, or motor 107.

The mower 100 may be configured to operate (e.g., cut grass) autonomously in the first operating mode as shown in FIG. 2. To minimize unintended and inadvertent blade contact with unknown objects when the mower is configured in the first operating mode, the cutting blade assembly 120 may be located at a first position as shown. When in the first position, a blade tip circle (the cutting diameter defined by outer tips of the blades 126 of the blade assembly 120) is spaced-apart from one sidewall (e.g., from the left sidewall 103a/trim edge) by a first distance 140 and, of course, by a corresponding distance 142 from the opposite sidewall (e.g., the right sidewall 103b). In some embodiments, the distances 140, 142 may be equal to one another and may be selected to locate the cutting blade assembly 120 centrally along the longitudinal axis of the mower. Stated another way, the cutting blade assembly is adapted to cut grass along a path located at the first distance from the sidewall 103 when the mower is configured in the autonomous first operating mode (such first operating mode corresponding to the first position of the cutting blade assembly).

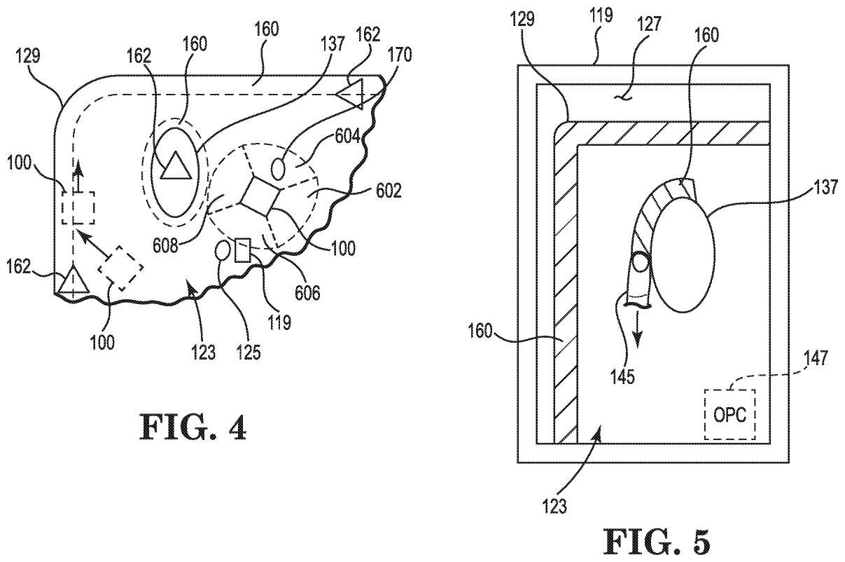

As used herein, “unknown objects” refers to those objects (see, e.g., unknown object 170 in FIG. 4) within the work region (or a local area of operation within the work region) detected by the controller 112 via the sensor 131, but for which the controller does not expect the mower 100, based upon previous training, to encounter. Examples of unknown objects include but are not limited to humans, animals, other yard vehicles, and debris. Unknown objects may include both moving and stationary objects. The controller 112 may respond differently when encountering different unknown objects. For example, the controller 112 may be able to determine that the unknown object is a person and cause the mower to behave differently than if the unknown object is determined to be something other than a person. Moreover, for purposes of this description, a person, animal, or object that the mower actually “recognizes” (e.g., via facial recognition, reference data, or object detection) as an operator, resident, pet, wildlife, toy, debris, etc. may still be tagged or categorized as an unknown object with regard to whether the mower will autonomously change between the first and second operating modes or take other action (e.g., stop, slow, turn, disable cutting, etc.).

As used herein, “local area of operation” is defined as an operational zone surrounding the mower during normal operation. For example, the local area of operation may include an area or areas adjacent one or more of the front, left, right, and rear sides of the mower. In some embodiments, the local area of operation may be directionally constrained to the direction of mower travel (e.g., limited to areas forward of the mower during forward travel). However, in other embodiments, the local area of operation may include any area selected from or adjacent to one or more of the front, left, right, and rear sides of the mower up to and including a full 360 degrees around the mower (see, e.g., local areas of operation 602, 604, 606, and 608 in FIG. 4). Further, the local area of operation may be outwardly constrained. For example, the local area of operation may encompass a moving zone extending 360 degrees around the mower. The actual size/radius of the local area of operation may depend on one or more factors. For example, the actual speed of the mower could be monitored, wherein a larger size/radius of the local area of operation would be utilized during faster travel and a smaller size/radius used for slower travel. The size/radius of the local area of operation may also be influenced by an estimated time it takes for cutting blade assembly 120 to stop rotation (e.g., for slower response, the size/radius may be larger). In some embodiments, the size/radius of the local area of operation could further be dynamically adjusted during operation based upon mower speed and/or other parameters (e.g., speed of an approaching unknown object).

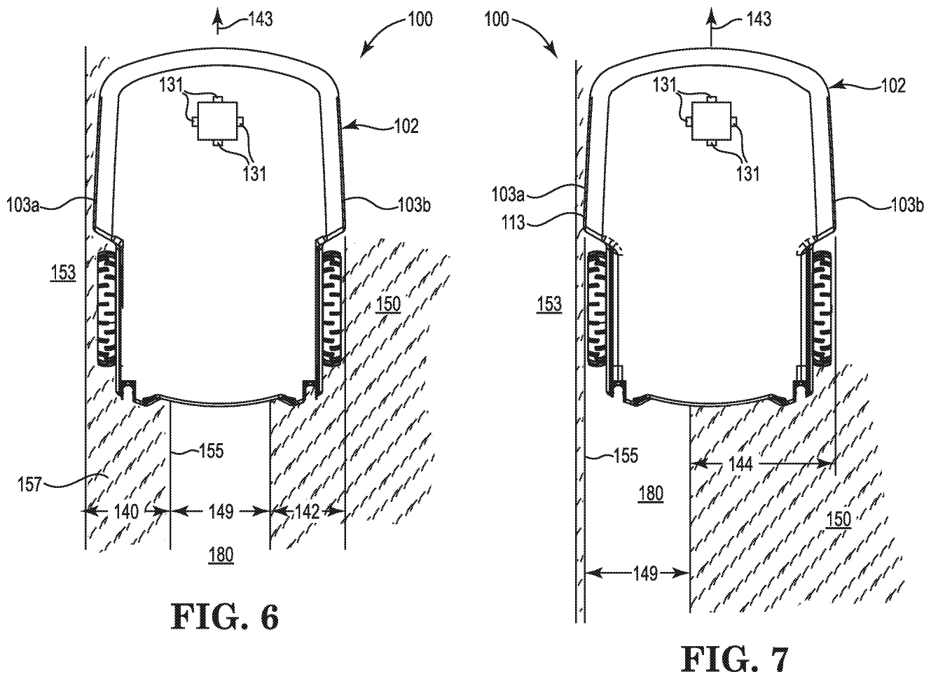

Conversely, when the mower 100 is operating in the second operating mode as shown in FIG. 3, operational portions of the cutting blade assembly 120 (e.g., the blades 126 that define the blade tip circle) are shifted to a second position that is spaced-apart from the sidewall 103a/trim edge 113 by a second distance 146 that is less than the first distance 140 (see FIG. 2). When the mower 100 is configured in the second operating mode, the cutting blade assembly 120 may be located such that the blades 126 are also spaced-apart from the right sidewall 103b by a distance 144 greater than the distance 142 (the latter distance corresponding to the mower 100 being in the first operating mode as shown in FIG. 2). Stated another way, the cutting blade assembly may laterally shift or move relative to the housing 102 as the mower is reconfigured or switched between the first and second operating modes. As a result, the mower/cutting blade assembly 120 is adapted to autonomously cut grass along a path defining a proximal cut edge 155 (see FIG. 6) located at first distance 140 from the sidewall 103a when the mower 100 is configured in the first operating mode, and at the second distance 146 from the sidewall when the mower is configured in the second operating mode (the second distance being less than the first distance). However, in the embodiments illustrated in FIGS. 2 and 3, a cutting width 149 of the mower 100 may remain the same regardless of the particular operating mode.

The second operating mode allows the mower 100 to cut grass along areas adjacent to obstacles, such areas being otherwise unreachable by the cutting blade assembly 120 when the mower is in the first operating mode (i.e., when the cutting blade assembly 120 is in the first position shown in FIG. 2). For example, in the second operating mode, the blade tip circle (which defines the proximal cut edge) of the cutting blade assembly 120 may be at, or even outwardly beyond, outside edges of the left rear and front wheels 106a, 108a as shown in FIG. 3. As a result, the blades 126 may cut grass near or transversely beyond a wheel track (outer edge) of the left rear wheel 106a as indicated by the dotted line in FIG. 3. Still further, in some embodiments, the power provided to the cutting blade assembly 120 by the motor 107 may increase (or decrease) when the mower is placed in the second operating mode.

In one example embodiment, a method for operating the mower may include locating the mower 100 within a defined work region 123 (see FIG. 4). The mower may include a cutting blade assembly (e.g., assembly 120) having at least one selectively-activated cutting blade (e.g., blade 126). As described above, the cutting blade assembly may be adapted to cut grass along a path defining a proximal cut edge (see, e.g., edge 155 in FIGS. 6-7) located at the first distance 140 (see, e.g., FIG. 2) from the sidewall 103a of the mower when the mower is configured in the autonomous first operating mode, and at the second distance 146 (see, e.g., FIG. 3) from the sidewall when the mower is configured in an autonomous second operating mode, the second distance being less than the first distance. The method may, in some embodiments, further include: autonomously operating the mower in the second operating mode within the work region; automatically detecting, with an electronic controller (e.g., controller 112) associated with the mower, an unknown object within the local area of operation of the mower; automatically switching, with the controller, the mower from the second operating mode to the first operating mode; and autonomously operating the mower in the first operating mode. Of course, this method of operation is exemplary only and other methods are certainly contemplated based upon the functional capabilities of the embodiments described and illustrated herein.

Advantageously, the ability to autonomously reconfigure the mower 100 between the first and second operating modes allows the mower to operate with the blades 126 recessed (into the housing 102) as shown in FIG. 2 when the controller 112 detects particular unknown objects within the mower's local area of operation. However, upon detecting the need to trim and determining that the local area of operation of the mower is free of unknown objects, the mower 100 (e.g., controller) may automatically switch or reconfigure from the first operating mode to the second operating mode shown in FIG. 3 and continue to autonomously operate in the second operating mode. As a result, the mower may be able to mow areas inaccessible when the mower 100 is in the first operating mode (when the cutting blade assembly 120 is in the first position of FIG. 2). The mower 100 may thus maintain a property more effectively and potentially without the need for separate manual trimming operations.

In some embodiments, the mower 100 may automatically re-configure itself to the second operating mode upon reaching a boundary of the work region, wherein such boundaries may be trained during a training phase.

During the training phase, the boundary, or a portion thereof, of the work region may be designated as a trim path 160, as shown by the exemplary property boundary 129 and landscape island boundary 137 of the exemplary work region 123 shown in FIG. 4. When the mower 100 is so trained, it may, upon reaching the trim path of the boundary 129 or 137, automatically switch from the first operating mode to the second operating mode (e.g., if no relevant unknown objects are present) and begin to move along the respective trim path 160.

Alternatively, one or more trim paths may be designated by an operator 125 after the training phase. For instance, the trained work region may be graphically presented on a display 127 of the remote computer 119 as shown in FIG. 5. The operator may, using his or her finger 145 as shown, manually draw or otherwise identify a desired trim path 160.

Regardless of how the trim path(s) 160 is ultimately designated, the mower 100 may automatically switch to the second operating mode upon reaching a trim path and then trim along the trim path (e.g., see broken line mower 100 representations in FIG. 4). While the mower may travel along the trim path during this operation, in other embodiments it may intermittently trim. That is, the mower 100 could continue to mow in a generally random pattern, switching to the second operating mode only when reaching a designated trim path.

Instead of automatically switching to the second operating mode, the mower 100 could instead notify the operator 125 (e.g., the radio 117 may transmit a notification to the remote computer 119) and request permission before the mower switches to the second operating mode, allowing the operator to approve and even visually supervise the trimming task. For instance, the operator 125 may physically enter the work region 123 as shown in FIG. 4 and, via wireless proximity detection or physical activation of an operator presence device (e.g., operator presence control (OPC) button 147 displayed on the remote computer 119 as shown in FIG. 5), approve operation of the mower in the second operating mode. Such an operational protocol allows the operator 125 to be physically present while the mower operates in the second operating mode.

While described herein as operating in the second operating mode during trimming, such operation is not limiting. That is to say, the mower 100 could automatically switch to the second operating mode during mowing of free space (assuming no unknown objects are detected) where such operation is beneficial and/or when operator presence is detected (e.g., by activation of the OPC button 147). For example, if the mower is operating in the first operating mode, the controller may monitor the local area of operation and determine if a previously identified unknown object is no longer present within the local area of operation. If that is the case, the controller may automatically switch the mower from the first operating mode to the second operating mode and continue autonomous operation. Moreover, while described in some embodiments herein as autonomously switching operating modes, such a configuration is not limiting. For instance, in some embodiments, the mower may switch between the first and second operating modes based upon an instruction received from the operator as indicated above, e.g., via interaction with the remote computer 119, or via an input (screen or keyboard) on the mower itself.

FIG. 6 illustrates the mower 100 while mowing a work region 150 in the first operating mode. In the first operating mode, the cutting blade assembly 120 is positioned as shown in FIG. 2. An obstacle 153 (e.g., boundary 129, boundary 137, building, etc.) may be adjacent the work region 150. As the mower 100 moves forwardly as indicated by arrow 143, the mower is able to cut grass in the work region 150 along a path 180 having a cutting width 149 (see also FIG. 2), the path defining the proximal cut edge 155. As already described herein, a location of the cutting width 149 (when the mower 100 is operating in the first operating mode) may be generally longitudinally centered along the housing 102. As a result, the mower 100 may leave a narrow portion of uncut grass 157 between the path 180 of the cutting blades 126 and the obstacle 153. In practice, the mower 100 may not actually mow continuously along the obstacle 153 but rather may move in a random, semi-random, or planned pattern throughout the work region 150. Nonetheless, the distances 140 and 142 shown in FIG. 6 present the potential issue with respect to mowing relative to the obstacle 153.

FIG. 7, on the other hand, illustrates the exemplary mower 100 of FIG. 3 operating in the same general area of the work region 150 while in the second operating mode. As stated above, the second operating mode allows lateral shifting of the cutting blade assembly 120/cutting blades 126 toward a trim edge 113 (e.g., transversely relative to the left sidewall 103a) of the mower, thereby allowing the mower to cut grass more closely to the boundary/obstacle 153 than the mower may be able to achieve in the first operating mode. That is, with the cutting blade assembly 120 now shifted as shown in FIG. 7, the cutting width 149 remains the same, but the location or path 180 of the cutting width 149 is now transversely shifted, relative to the housing 102, toward the left sidewall 103a as shown.

As stated herein, the mower 100 may be automatically reconfigured between the first operating mode (FIG. 2) and the second operating mode (FIG. 3) in response to object detection algorithms executed by the controller 112 based upon sensor feedback. For example, during operation, a vision-based sensor (e.g., cameras 131; see FIG. 1) in communication with the controller may, in addition to other functions, be utilized to detect unknown objects that enter the local area of operation. Upon detection of an unknown object within the local area of operation, the mower may automatically switch to (or remain in) the first operating mode. As a result, the opportunity for unintended contact of the blade assembly 120 with the unknown object is reduced.

To provide the above-identified functionality, the controller 112 may utilize computer vision algorithms and machine learning to recognize objects within digital images captured by the cameras 131 (see, e.g., FIG. 1). As used herein, “object recognition” may be used to refer to various computer vision capabilities for identifying objects within a digital image. These computer vision capabilities may include algorithms for: image classification; object localization; object segmentation; and object detection.

In image classification, the controller may analyze an image and classify the image into one or more various categories (i.e., determining what is contained within the image). For example, image classification algorithms may classify an image as containing a human body or face, a dog, and/or a tree. Object localization and segmentation may go a step further by, in addition to classifying the image, locating the detected object at a specific location within the image and delineating the same with a bounding box or, in the case of object segmentation, creating a pixel-by-pixel mask of the object. By iteratively applying classification and localization/segmentation algorithms to an image, object detection may yield a list of object classifications present in the image, as well as a bounding box or mask indicating the location and scale of each object.

If no unknown objects are detected in the analyzed image(s), the mower may reconfigure autonomously to (or remain in) the second operating mode and operate therein. In practice, the mower 100 may make a determination regarding operating modes based upon images from all four cameras 131 or based upon images from any one or more cameras 131. For instance, when travelling in the forward direction (see arrow 143 in FIG. 6), the controller may analyze only images captured from the forward camera and, optionally, one or both of the left and right cameras, i.e., it may disregard images from the rear camera 131 as objects behind the mower may be of less concern. However, other embodiments may monitor images from all cameras (including the rear camera) as such data may detect a moving unknown object approaching from any direction. Upon such detection, the mower may return to (or remain in) the first operating mode and continue to operate.

In addition to utilizing the cameras 131, other embodiments may alternatively or in addition, use other (e.g., redundant) sensors to assist with transitioning the mower between the first and second operating modes. For example, one or more remote sensors 162 (see FIG. 4) may be located in or near the work region. For example, the remote sensor may be attached to a pole, to a building in or near the work region, or to any object that allows the sensor to provide effective monitoring. In addition to such “fixed location” remote sensors, other embodiments may use a travelling remote sensor such as another autonomous ground vehicle or aerial drone.

In one example, the remote sensor 162 is an image sensor (e.g., camera, motion sensor, etc.) that is adapted to monitor some (e.g., trim paths) or all of the work region 123 during mower operation. The remote sensor 162, which may wirelessly communicate with the mower (e.g., either directly or via a local- or wide-area network), may also detect unknown objects in and around the mower or in or around a particular portion of the work region. Prior to the controller 112 issuing a command to reconfigure the mower from the first operating mode to the second operating mode, the controller 112 may analyze information from the remote sensor 162 to confirm that the unknown object is no longer present within the local area of operation. If such confirmation fails, the mower may not proceed to the second operating mode, but rather may take other action (e.g., slow, turn, stop, stop blade operation, notify the remote computer, etc.). Accordingly, such remote sensors may provide redundancy to the mower's onboard sensors (e.g., cameras 131) regarding detection of unknown objects. While the redundant sensor is described above as being remotely-located from the mower, such a configuration is exemplary only as other embodiments may include a redundant sensor (in addition to the cameras 131) located on the mower itself.

In addition to switching to the first operating mode, mowers in accordance with embodiments of the present disclosure may, alternatively or in addition, slow propulsion the drive wheels 106. For example, upon detection of an unknown object in the local area of operation, the controller 112 may slow or stop propulsion by slowing or stopping the drive wheels 106. If the unknown object moves out of the local area of operation, the mower may resume normal speed and advance without exiting the second operating mode. However, if the unknown object remains within the local area of operation and/or moves closer toward the mower 100, the controller 112 may proceed with reconfiguring the mower to the first operating mode or even disabling the blade assembly 120. In yet other embodiments, the mower may execute a turn to move away from the unknown object and/or notify the remote computer 119.

Most any mechanism that permits unattended shifting of the cutting blade assembly 120 is contemplated. For example, the motor 104 may be directly coupled to the cutting blade assembly 120 such that the motor and cutting blade assembly together shift, under control of the controller 112, along a slot 135 (see FIG. 3) defined within the upper wall 111 as the cutting blade assembly moves between its first and second positions.

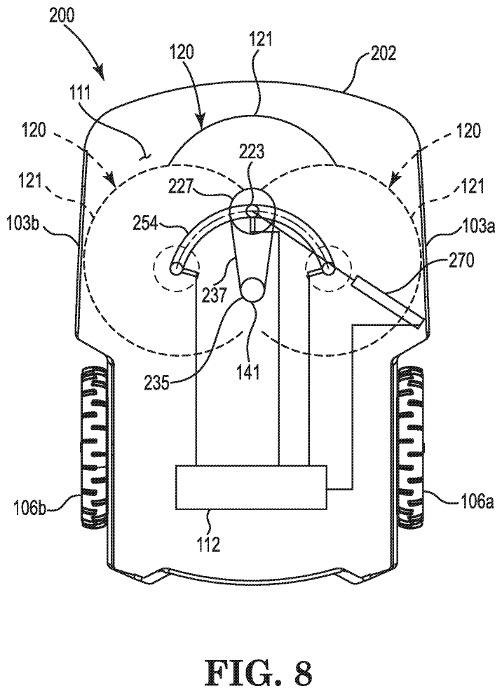

FIG. 8 illustrates a variation of this concept. As shown in this bottom view, an exemplary mower 200 is provided with a housing 202 and cutting blade assembly 120 (illustrated diagrammatically in this view by blade tip circle 121) movable relative to a fixed output shaft 141 of the motor 107 (note that those parts/features of the mower 200 that are similar or identical to like parts of the mower 100 are identified with the same, e.g., one hundred (1xx) series, reference numerals). That is to say, the motor 107 may remain stationary as the blade assembly 120 moves between first and second (or more) positions.

As shown in FIG. 8, the cutting blade assembly 120 may include an independent shaft 223 having a driven sheave 227 coupled, by a drive belt 237, to a driving sheave 235 attached to the output shaft 141. The shaft 223 may slide along a curved slot 254 that, in one embodiment, is centered about an axis of the output shaft 141.

When the mower 200 is configured in the first operating mode, the blade assembly 120/circle 121 may be centered on the housing 102 in the first position as partially shown in solid lines. However, the slot 254 may accommodate physical movement (e.g., sliding) of the cutting blade assembly 120/shaft 223 toward one or both of the left sidewall 103a and the right sidewall 103b to accommodate operation of the mower in the second operating mode (indicated by broken line blade tip circles 121).

The exemplary mower 200 may include an actuator, e.g., an electric ball screw 270, operatively connected to a support of the shaft 223 of the cutting blade assembly and to the housing 202, wherein the actuator, when energized (extended/retracted), is adapted to shift the cutting blade assembly 120 between the first and second positions (corresponding to the first and second operating modes, respectively, of the mower). For example, the controller 112 may selectively rotate the ball screw, causing the cutting blade assembly 120 to slide along the slot 154 between the first position and the second position, displacing the cutting blade assembly relative to the housing 202/upper wall 111. Accordingly, the screw 270 may automate movement of the cutting blade assembly 120 (e.g., under control of the controller 112) relative to the upper wall/housing between the first and second positions.

The embodiments illustrated in FIGS. 2-3 and 6-8 are thus able to achieve two operational modes of the mower via shifting of the cutting blade assembly 120. While effective for border trimming, such embodiments are still limited by a cutting width that is substantially smaller than the width of the mower housing 102.

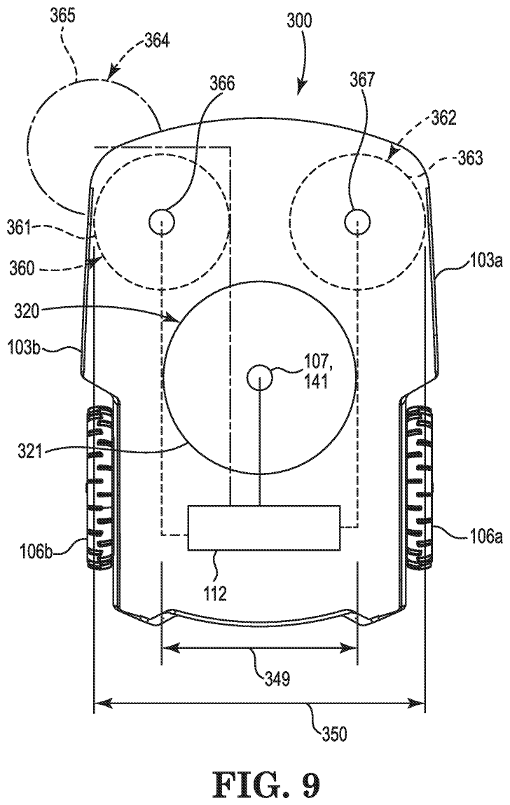

FIG. 9 diagrammatically illustrates another embodiment of the present disclosure that also provides a mower 300 having the desired two operating modes. However, unlike the embodiments of FIGS. 2-3 and 6-8, the mower 300 illustrated in FIG. 9 utilizes a cutting blade assembly that includes separate powered cutting blade assemblies transversely spaced-apart from one another and that may be independently activated or energized by the controller to allow operation of the mower in the first and second operating modes. That is, instead of shifting a single cutting blade assembly, the mower 300 may include a powered first cutting blade assembly 320 that operates alone (e.g., with the second cutting blade assembly deactivated) for mower operation in the first operating mode (wherein again, the first operating mode provides a generous offset of the blade tip circle 321 from the sidewalls 103), and one or more powered second cutting blade assemblies 360, 362. The second cutting blade assemblies (located proximate respective sidewalls in the illustrated examples) are powered by motors (e.g., motors 366 and 367, respectively). The motors, 366, 367 may be independently activated by the controller when the mower is in the second operating mode but be deactivated when the mower is in the first operating mode. That is, the controller may independently and separately control rotation of the first and second cutting blade assemblies. While shown as being of different sizes, the cutting blade assemblies 320, 360, and 362 could be identical without departing from the scope of this disclosure. By powering the first cutting blade assembly 320 and one or both of the assemblies 360 and 362 simultaneously, the mower 300 may not only provide the ability to trim around boundaries/obstacles, but may also operate with an increased cutting width (as compared to the width provided by the single cutting blade assembly 320 in the first operating mode).

On its own, the first cutting blade assembly 320 provides a cutting width 349 as defined by its blade tip circle 321. As one can appreciate, the mower 300 may thus mow in a manner similar to the mower 100 as shown in FIG. 6 (when configured in its first operating mode). However, when the controller 112 determines that operational parameters are satisfied (e.g., sensor feedback from the cameras 131 does not indicate an unknown object in the local area of operation), motors 366, 367 (or clutches; not shown) associated with the second cutting blade assemblies 360, 362, respectively, may be activated. The second cutting blade assemblies 360, 362, which again may be configured in a manner similar to, but be potentially smaller than, the blade assembly 120 described above, may thus rotate and define cutting paths (defined by their respective blade tip circles 361 and 363) that overlap the cutting path defined by the first cutting blade assembly 320. Accordingly, the mower 300 may, when in the second operating mode, provide a cutting width 350 that is larger than the cutting width 349. In fact, the cutting width 350 may be approximately equal to the width of the mower housing 102. As described elsewhere herein, the controller 112 may be adapted to automatically disable the second cutting blade assemblies 360, 362 while maintaining operation of the first cutting blade assembly 320 when an unknown object is detected within the local area of operation.

While shown as having two second cutting blade assemblies 360, 362, such a configuration is exemplary only as embodiments having only one (or three or more) second cutting blade assemblies are also contemplated. Moreover, while described above as energizing motors associated with both second cutting blade assemblies 360, 362 simultaneously, other embodiments may activate and deactivate these motors independently. For example, when the mower 300 is operating in the second operating mode and the controller 112 detects an unknown object approaching on its left side, it may deactivate the left cutting blade assembly 362 while permitting the right cutting blade assembly 360 to continue operation.

In still other embodiments, the mower could, in addition or alternatively to one or of both the second cutting blade assemblies 360, 362 provide yet another cutting blade assembly 364 defining a blade tip circle 365. In some embodiments, the cutting blade assembly 364 may be powered by its own motor (not shown) or clutched/declutched off of another blade motor. As is evident in FIG. 9, the cutting blade assembly 364 may extend beyond the cutting chamber/housing to permit more versatile trimming. For instance, the cutting blade assembly 364 may be configured as a string trimmer head that may be selectively activated and deactivated by the controller 112 as needed (e.g., to trim around trees, fence posts, etc.).

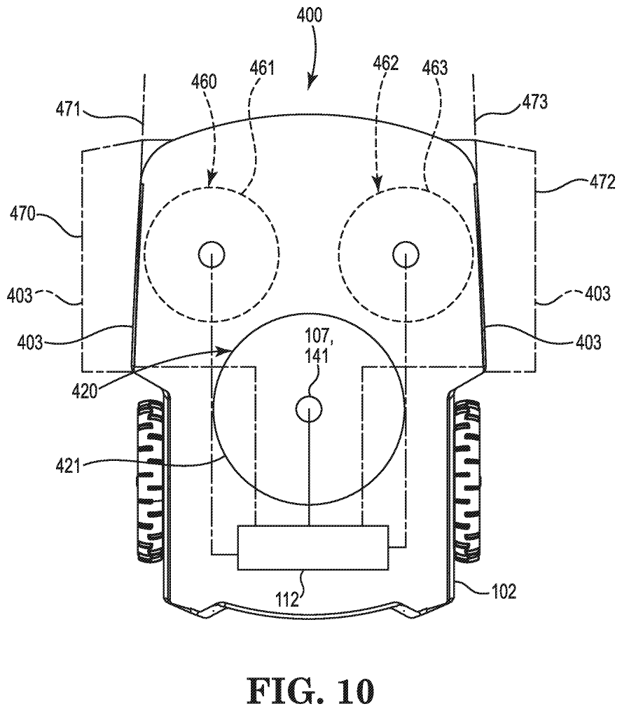

FIG. 10 illustrates a mower 400 in accordance with yet other embodiments of the present disclosure. Similar to the mower 300 of FIG. 9, the mower 400 may include a first cutting blade assembly 420 (defining a blade tip circle 421) and second cutting blade assemblies 460, 462 (defining blade tip circles 461, 463 respectively). Unlike the mower 300, however, all three cutting blade assemblies may be activated during both the first and second operating modes. To provide the blade offsets desired in the first operating mode, the mower 400 may include two (left and right) shrouds 470, 472 that are attached to the housing 102 such that they may pivot about pivot axes 471, 473, respectively.

When the mower 400 is in the first operating mode, the shrouds may be in a first position as illustrated in FIG. 10. In this first position, the shrouds form the respective sidewalls 403 of the housing 102 and provide the desired offset spacing between the sidewalls and any moving portion of the cutting blade assemblies 420, 460, and 462.

To configure the mower in the second operating mode, the shrouds 470, 472 may be pivoted about the axes 471, 473, respectively, by actuators (not shown) under the control of the controller 112, to a second position. In some embodiments, the shrouds may pivot upwardly to the second position, effectively moving out of the way and permitting the sidewalls 403 to effectively move inwardly relative to the blade assemblies (see solid line renderings of sidewalls 403 in FIG. 10). As a result, the mower 400 may be automatically switched between the first operating mode and the second operating mode not by movement or selective activation of the cutting blade assemblies, but rather by moving a sidewall of the mower relative to the cutting blade assembly. In still other embodiments, the shroud/sidewall could be completely removed from the housing to place the mower in the second operating mode.

While shown as providing dual second cutting blade assemblies and corresponding left and right movable shrouds, embodiments using only one second cutting blade assembly and one movable shroud are also possible. Similarly, a single larger cutting blade assembly 420 could be used, potentially negating the need for the second cutting blade assemblies.

Illustrative embodiments are described and reference has been made to possible variations of the same. These and other variations, combinations, and modifications will be apparent to those skilled in the art, and it should be understood that the claims are not limited to the illustrative embodiments set forth herein.

1. An autonomous lawn mower comprising:
a housing comprising a downwardly extending sidewall;
ground support members adapted to support the housing upon a ground surface of a work region in which the mower operates; and
a cutting blade assembly supported by the housing and comprising at least one selectively-activated cutting blade, wherein the cutting blade assembly is adapted to cut grass along a path defining a proximal cut edge located at a first distance from the sidewall when the mower is configured in a first operating mode, and at a second distance from the sidewall when the mower is configured in a second operating mode, the second distance being less than the first distance, and wherein the mower is adapted to automatically switch from the first operating mode to the second operating mode when an electronic controller associated with the mower determines a local area of operation of the mower is free of unknown objects.

2. The mower according to claim 1, wherein the cutting blade assembly shifts laterally, relative to the housing, as the mower automatically switches between the first and second operating modes.

3. The mower according to claim 1, wherein the sidewall moves, relative to the cutting blade assembly, as the mower automatically switches between the first and second operating modes.

4. The mower according to claim 1, wherein the cutting blade assembly comprises a powered first cutting blade assembly and a powered second cutting blade assembly, and wherein the second cutting blade assembly is activated when the mower is in the second operating mode and is deactivated when the mower in in the first operating mode.

5. The mower according to claim 1, wherein the mower is adapted to automatically switch to the first operating mode upon detection of an unknown object within the local area of operation of the mower.

6. The mower according to claim 1, wherein the mower comprises a radio adapted to transmit a notification to a remote computer before the mower switches to the second operating mode.

7. A method for operating an autonomous lawn mower comprising:
locating the mower within a defined work region, wherein the mower comprises:
a housing comprising an upper wall and a downwardly extending sidewall;
wheels adapted to support the housing in rolling engagement upon a ground surface; and
a cutting blade assembly comprising at least one selectively-activated cutting blade, wherein the cutting blade assembly is adapted to cut grass along a path defining a proximal cut edge located at a first distance from the sidewall when the mower is configured in an autonomous first operating mode, and at a second distance from the sidewall when the mower is configured in an autonomous second operating mode, the second distance being less than the first distance;
autonomously operating the mower in the second operating mode within the work region;
automatically detecting, with an electronic controller associated with the mower, an unknown object within a local area of operation of the mower;
automatically switching, with the controller, the mower from the second operating mode to the first operating mode; and
autonomously operating the mower in the first operating mode.

8. The method according to claim 7, further comprising:
monitoring, with the controller, the local area of operation;
detecting when the unknown object is no longer present within the local area of operation;
automatically switching, with the controller, the mower from the first operating mode to the second operating mode; and
autonomously operating the mower in the second operating mode.

9. The method of claim 8, further comprising confirming that the unknown object is no longer present within the local area of operation using a remote sensor.

10. The method according to claim 7, wherein switching the mower from the second operating mode to the first operating mode comprises laterally shifting the cutting blade assembly toward the sidewall.

11. The method according to claim 10, wherein shifting the cutting blade assembly toward the sidewall comprises extending or retracting an actuator operatively connected to the housing and to the cutting blade assembly.

12. The method according to claim 10, wherein the upper wall further defines a slot, and wherein the cutting blade assembly is slidable along the slot between a first position corresponding to the first operating mode of the mower, and a second position corresponding to the second operating mode of the mower.

13. The method according to claim 7, wherein the cutting blade assembly comprises a powered first cutting blade assembly and a powered second cutting blade assembly, and wherein switching the mower from the second operating mode to the first operating mode comprises deactivating the second cutting blade assembly while maintaining power to the first cutting blade assembly.

14. The method according to claim 7, wherein switching the mower from the second operating mode to the first operating mode comprises operatively moving or removing the sidewall.

15. The method according to claim 7, wherein detecting the unknown object within the local area of operation comprises detecting the unknown object using a vision-based sensor in communication with the controller.

16. The method according to claim 7, further comprising slowing propulsion of the mower when the unknown object is detected within the local area of operation.

17. The method according to claim 7, further comprising stopping propulsion of the mower when the unknown object is detected within the local area of operation.

18. A lawn mower comprising:
a housing comprising a downwardly extending sidewall;
ground support members adapted to support the housing upon a ground surface;
first and second cutting blade assemblies carried by the housing, wherein the first and second cutting blade assemblies are transversely spaced-apart from one another with the second cutting blade assembly being located proximate the sidewall;
an electronic controller adapted to control rotation of the first and second cutting blade assemblies; and
a sensor in communication with the controller, wherein the controller, via the sensor, is adapted to detect a presence of an unknown object within a local area of operation of the mower, and wherein the controller is adapted to automatically disable the second cutting blade assembly while maintaining operation of the first cutting blade assembly when the unknown object is detected within the local area of operation.

19. The mower according to claim 18, wherein the sensor comprises a vision-based sensor.

20. The mower according to claim 18, wherein the local area of operation comprises an area adjacent one or more of front, left, right, and rear sides of the mower.
